(19) United States
(12) Patent Application Publication
(10) Pub. No.: US 2026/0293794 A1
(43) Pub. Date: Oct. 1, 2026

(54) TOWED AGRICULTURAL IMPLEMENT WITH WINGED FRAME AND CONTROLLER TO ASSIST OPERATION OF THE IMPLEMENT

(71) Applicant: ELMER'S WELDING & MANUFACTURING LTD., Altona (CA)

(72) Inventors: Chad Barnabe, Altona (CA); Rheal Boileau, Altona (CA); Owen Darrach, Altona (CA)

(21) Appl. No.: 19/709,585

(22) Filed: Jun. 16, 2026

Related U.S. Application Data
(62) Division of application No. 18/732,841, filed on Jun. 4, 2024.
(60) Provisional application No. 63/568,586, filed on Mar. 22, 2024.

(51) Int. Cl. A01B 73/06

(52) U.S. Cl. CPC A01B 73/065

(57) ABSTRACT

A harrow or tillage implement comprised of a tool bar(s) with sections, gangs, or individual tools attached with a controller, and series of monitoring sensors. Such an implement with one or more automated systems to assist the operator with the tasks required to successfully operate the implement. These systems together can provide more consistent transitions between transport and field, minimize the probability of damage during operation, and work to ensure the implement is operating as intended.

This application is a divisional of US parent application Ser. No. 18/732,841, filed Jun. 4, 2024, which claims the benefit under 35 U.S.C. 119(e) of U.S. provisional application Ser. No. 63/568,586, filed Mar. 22, 2024.

### FIELD OF THE INVENTION

The present invention relates to a toward agricultural implement having a winged frame, for example an agricultural harrow implement, and more particular the present invention relates to towed, winged, agricultural implement having a controller on the implement that executes one or more functions associated with the implement in response to sensed operating characteristics of the implement to assist operation of the implement.

### BACKGROUND

As harrows and other tillage implements includes a tool bar(s) with a plurality of sections or gangs made up of multiple ground engaging tools, or individually mounted ground engaging tools attached running perpendicular to the operating direction of travel. Each is mounted using movable linkage(s), compliant mechanisms, or rigidly such that the tools bear against, or into the ground.

A typical harrow section typically consists of a frame extending rearward from the tool bar and connected by a support bar or linkage. Evenly spaced support bars perpendicular to the operating direction of travel carry a series of evenly spaced flexing harrow tines. The support bars are typically rotatable such that the angle the tines engage the ground may be varied. The pitch of the harrow sections is typically adjustable by rotating the tool bar, or lifting the front or rear of the frame arms such that the tines bear greater force on the ground at the front or back. Harrow sections are typically biased such that weight from the tool bar may be transferred to the sections, or vice versa. This system typically uses a sprung configuration or a single pressure control valve that can be configured to vary the amount of bias and control the amount of force applied to the ground. Harrows typically include provisions which allow for the tool bar to rotate such that the sections are raised into a vertical position. This allows the harrow to be folded for transport, typically into a rearward trailing configuration.

Other tillage implements typically consist of gangs or groups of disks joined together and mounted to a tool bar, or individually mounted tools like disks or shanks connected directly to the tool bar. The depth of cut is adjustable by lifting and lowering the frame of the implement, such that the implements entire weight may bear on the tools. The angle of attack, or angle between the disks and the direction of travel is becoming a more common adjustment allowing for greater flexibility in the workable conditions and overall field finish. Typically, these implements have provisions for leveling the tools front to back relative to the ground, allowing for varied hitch heights, and a more consistent cut depth in rolling terrain. The tools on these implements are typically mounted more rigidly than a harrow, allowing for forward and vertical folding configurations for transport.

Regardless of the configuration, harrows and other tillage implements traditionally have a heavy operator workload to maximize the machines performance. Unlike other workload heavy and or high-speed operations such as seeding and spraying, operators of ground working implements such as harrows are required to manually adjust the implement on the go to optimize for tractor performance and field finish, while also monitoring for other hazards and potential issues.

Furthermore, agricultural implements have traditionally relied on spool valves for the control of hydraulic circuits. Spool valves provide cost effective and efficient control of directional, or double acting hydraulic actuators. However, these valves are known to leak at a relatively high rate under pressure from new. Typical leakage ratings of these valves can be around or well above 166 ml per minute (10 L per hour) depending on the exact valve style, size, and loading. This makes these valves unsuitable for load holding applications, but they are commonly used in agriculture for load holding during shoer time frames for simplicity and controllability. As implements and fields get larger the leakage rate of these valves becomes a more significant problem when looking to maintain constant settings and field finish. Traditionally this is combated by relying on operator intervention, or additional zero leak valving. Even when zero leak valving in included it is common for setting adjustments to be difficult when operating at full load in the field.

Furthermore, as agricultural implements have grown in width, while maintaining transportable folding sizes along, the number of sections, or gangs of ground engaging tools that must be synchronized has increased significantly. To maximize adjustability, uptime, and convenience these systems commonly rely on phased hydraulic circuits, or cylinders connected in series such that the motion of one cylinder is tied to the remaining cylinders. Common uses are adjustments such as tine or disk angle, cut depth, and more. These phased hydraulic systems commonly suffer from internal leakage in the hydraulic cylinder leading to out of phase drift; allowing cylinders to move relative to one another. This change in adjustment causes an uneven finish across the implement, which can greatly influence the performance. For example, when tines become out of phase, one frame section may inadvertently be set to a more aggressive tine angle which creates an uneven finish across the working width of the machine, which as discussed compromises the overall performance of the implement. Such implements of the prior art rely on the operator to periodically “phase” the system to correct any imbalances and maintain a consistent field finish. For an implement requiring depth adjustment this problem is commonly solved by fully lifting the implement at the end of each pass which phases the system. For adjustments not commonly actuated to their extremes during regular use it becomes a challenge to identify cylinder out of phase drifting and correct it.

Additionally, as these systems incorporate more and more cylinders, and or are towed by tractors of ever-increasing size it becomes more common to see phased cylinder circuits drift in unison, while also seeing single cylinder circuits drift in some cases. In the prior art this is due to leakage through directional spool valves on the equipment or tractor and has been solved with the use of separate valves with zero leakage for each direction, or additional zero leakage valving, but this can be costly.

### SUMMARY OF THE INVENTION

According to one aspect of the invention there is provided a towed agricultural implement comprising:
a central frame arranged for connection to an agricultural tractor for movement across ground in a forward working direction of the agricultural tractor;
two wing frames pivotally coupled to the central frame so as to be moveable relative to the central frame between a field position in which the wing frames extend laterally outward in opposing lateral directions from the central frame and a transport position in which the wing frames extend rearwardly in trailing relation to the central frame;
at least one implement condition sensor arranged to detect an operating characteristic of the implement relating to an operating condition of the wing frames; and
a controller supported on the implement in communication with said at least one implement condition sensor, the controller comprising a memory storing programming instructions thereon and a processor arranged to execute the programming instruction whereby the controller is arranged to generate an instruction for guiding the wing frames of the implement between the field position and the transport position responsive to the operating characteristic sensed by said at least one implement condition sensor.

The implement as described herein is further arranged so that the controller can: (i) read sensor inputs such that the position of the implements frame members, actuators, field settings, and or other safety information may be captured, in which sensors used are typically angular & linear position sensors, and proximity sensors, and in which some or all these sensors may be replaced by technologies such as cameras, lidar, ultrasonics and others which can provide the control system with the same information; (ii) send control signals to electrical and electric over hydraulic actuators to modify the position of the implements frame members, actuators, and or field settings, in which control of said actuators may be based on the implement or on the tractor where control signals are sent over an ISO bus or another standardized machine interface; and interact with an operator through a wired or wireless user interface device such as a tablet communicating over any standardized communication protocol such as Ethernet, CAN, WiFi, Cellular standards or through an ISO bus or other standardized machine interface allowing implement to operator communication though a tractor.

The instruction described above may comprise a prompt communicated to the operator through a user interface.

When the user interface comprises a tractor interface of the agricultural tractor, the controller may be arranged to communicate with the tractor interface to communicate the prompt to the user.

When the user interface comprises a portable computer device supported remotely from the controller on the implement, the controller may be arranged to communicate with the portable computer device to communicate the prompt to the user.

When the implement includes a latch assembly arranged to latch the wing frames in the field position, the at least one implement condition sensor may comprise a latch sensor associated with the latch assembly whereby the operating characteristic sensed by the latch sensor comprises a latching condition of the latch assembly.

The at least one implement condition sensor may comprise a wing angle sensor associated with the wing frames whereby the operating characteristic sensed by the wing angle sensor includes a relative angle of one or both wing frames relative to the central frame.

When the implement includes a transport wheel mounted on each wing frame respectively to support the wing frame for rolling movement along the ground in which the transport wheel is pivotal about a wheel assembly axis between a field orientation and a transport orientation, the at least one implement condition sensor may comprise a wheel angle sensor associated with each transport wheel whereby the operating characteristic sensed by the wheel angle sensor includes a relative angle of the associated transport wheel relative to the respective wing frame.

When the implement comprises a plurality of component actuators for operating respective components of the implement between different operating positions, the instruction may comprise an actuation signal associated with one or more component actuators for guiding the wing frames of the implement between the field position and the working position responsive to the operating characteristic sensed by said at least one implement condition sensor.

When the components of the implement include a latch assembly arranged to latch the wing frames in the field position, one of the component actuators may comprise a latch actuator arranged to operate the latch assembly between a latched position and an unlatched position of the latch assembly, in which the actuation signal generated by the controller is arranged to actuate the latch actuator.

When the components of the implement include a transport wheel mounted on each wing frame respectively to support the wing frame for rolling movement along the ground in which the transport wheel is pivotal about an upright steering axis between a field orientation and a transport orientation, and the component actuators of the implement comprise wheel actuators arranged to operate the transport wheels between the field orientation and the transport orientation, the actuation signal generated by the controller is preferably arranged to actuate the wheel actuators.

In this instance, the at least one implement condition sensor may comprise a wing angle sensor associated with the wing frames whereby the operating characteristic sensed by the wing angle sensor includes a relative angle of one or both of the wing frames relative to the central frame, in which the controller is arranged to generate the actuation signals for the wheel actuators so as to dynamically vary orientation of the transport wheels responsive to said relative angle of one or both of the wing frames relative to the central frame.

When the components of the implement include a transport wheel mounted on each wing frame respectively to support the wing frame for rolling movement along the ground, the component actuators of the implement may comprise wheel motors arranged to drive rotation of the transport wheels respectively, in which the actuation signal generated by the controller is arranged to actuate the wheel motors.

When the implement includes a plurality of ground engaging tools supported on the main frame for selectively engaging the ground, one or more of the component actuators may comprise a tool deployment actuator arranged to operate the ground engaging tools between an engaged position and a disengaged position of the ground engaging tools relative to the ground, in which the actuation signal generated by the controller is arranged to actuate the tool deployment actuator.

According to a second aspect of the present invention there is provided a towed agricultural implement for use with an agricultural tractor having at least one hydraulic output, the implement comprising:
a main frame arranged for connection to the agricultural tractor for movement across ground in a forward working direction of the tractor;
a plurality of ground engaging tools supported on the main frame for selectively engaging the ground;
at least one hydraulic actuator supported on the implement and being arranged for connection to said at least one hydraulic output of the tractor so as to be operable to control an associated operating characteristic of the implement, said at least one hydraulic actuator being associated with one or more control valves to controllably vary said associated operating characteristic in response to a command signal;
at least one operating sensor supported on the implement so as to be arranged to sense said operating characteristic associated with said at least one hydraulic actuator; and
a controller supported on the implement in communication with said at least one operating sensor, the controller comprising a memory storing programming instructions thereon and a processor arranged to execute the programming instructions whereby the controller is arranged to (i) determine if the operating characteristic associated with said at least one hydraulic actuator falls within a threshold range associated with the command signal for said at least one hydraulic actuator, and (ii) generate a corrective command signal for said at least one hydraulic actuator to return the operating characteristic to the threshold range in response to the operating characteristic being outside of said threshold range.

In this regard, the implement using spool valves or other hydraulic control valving known to leak under load during normal operation, is further equipped with a sensor or series of sensors monitoring the position of the adjustment. Additionally, an implement of the prior art using zero leak valving on a circuit prone to over pressurization during regular use. An electronic control capable of monitoring the adjustment in question and sending control signals to the tractor or implement mounted hydraulic valving to correct any setting drift, or delay in the ability to reach the desired setting which occurs.

The controller may be further arranged to generate an alert for communication to the user if the operating characteristic does not return to the threshold range in response to the corrective command signal being directed to said at least one hydraulic actuator.

According to a third aspect of the present invention there is provided a towed agricultural implement for use with an agricultural tractor having at least one hydraulic output, the implement comprising:
a main frame arranged for connection to the agricultural tractor for movement across ground in a forward working direction of the tractor;
a plurality of ground engaging tools supported on the main frame for selectively engaging the ground;
a plurality of hydraulic actuators operatively connected to respective ones of the ground engaging tools to displace the tools through a range of operating positions relative to the main frame, the plurality of hydraulic actuators being (i) hydraulically linked to one another in a phasing relationship and (ii) arranged for connection to said at least one hydraulic output of the tractor such that the plurality of hydraulic actuators are operable together through said range of operating positions, the plurality of hydraulic actuators including phasing ports arranged to communicate hydraulic fluid between the hydraulic actuators when the hydraulic actuators reach respective end-of-travel positions for hydraulically resynchronizing the hydraulic actuators with one another in the end-of-travel positions;
at least one monitoring device arranged to monitor one or more operating characteristics of the implement relating to an operating condition of the ground engaging tools; and
a controller supported on the implement in communication with said at least one monitoring device, the controller comprising a memory storing programming instructions thereon and a processor arranged to execute the programming instructions whereby the controller is arranged to (i) determine if the plurality of hydraulic actuators can be displaced into said end-of-travel positions by comparing the one or more operating characteristics of the implement monitored by the at least one monitoring device to phasing criteria stored on the controller, and (ii) generate actuation signals for displacing the plurality of hydraulic actuators into said end-of-travel positions in response to determination that the plurality of hydraulic actuators can be displaced into said end-of-travel positions.

In this disclosure, an implement of the prior art using a phased hydraulic circuit in the control of an adjustment not regularly actuated to its extremes during regular use, is further equipped with a control system capable of adjusting the implement, while monitoring a series of sensors on the implement and data from the tractor. Based on the information received from these sources and user configurable inputs the system can determine appropriate times to phase these adjustments without interfering with normal operation, or compromising field finish.

The phasing criteria stored on the controller may relate to the operating condition of the ground engaging tools being in transition between different states whereby the controller will generate said actuation signals for displacing the plurality of hydraulic actuators into said end-of-travel positions in response to determination that the ground engaging tools are in transition.

The phasing criteria stored on the controller may relate to the ground engaging tools being disengaged from the ground and a duration since a previous displacement of the plurality of hydraulic actuators into said end-of-travel positions exceeding a duration threshold stored on the controller.

The controller may be further arranged to generate an alert for communication to the operator in response to failure to meet the phasing criteria for a duration since a previous displacement of the plurality of hydraulic actuators into said end-of-travel positions exceeding an alert threshold stored on the controller.

The at least one monitoring device may include sensors supported on the implement so as to be arranged to directly sense the operating condition of the ground engaging tools.

The at least one monitoring device may include a tractor interface arranged to communicate with a control system of the tractor to acquire tractor data representative of said one or more operating characteristics of the implement.

### BRIEF DESCRIPTION OF THE DRAWINGS

Some embodiments of the invention will now be described in conjunction with the accompanying drawings in which:

FIG. 1 is top view of the implement in a field position connected to an agricultural tractor;

FIGS. 2A, 2B, and 2C show the implement in a transport position, an intermediate transitioning position, and the field position;

FIG. 3 is a side view of one of the section frames of the implement which supports the tines for angular adjustment thereon;

FIG. 4 is a schematic representation of the communication between the tractor controller, the implement controller, and a portable computer device;

FIG. 5 is a schematic representation of an assisted mode of operation of the implement controller for transitioning between different wing positions;

FIG. 6 is a schematic representation of an automated mode of operation of the implement controller for transitioning between different wing positions;

FIG. 7 is a schematic representation of an automated phasing mode of operation of the implement controller for synchronizing actuators of the implement that are in a phasing relationship; and

FIG. 8 is a schematic representation of a drift correction mode of operation of the implement controller for correcting drift of actuators of the implement.

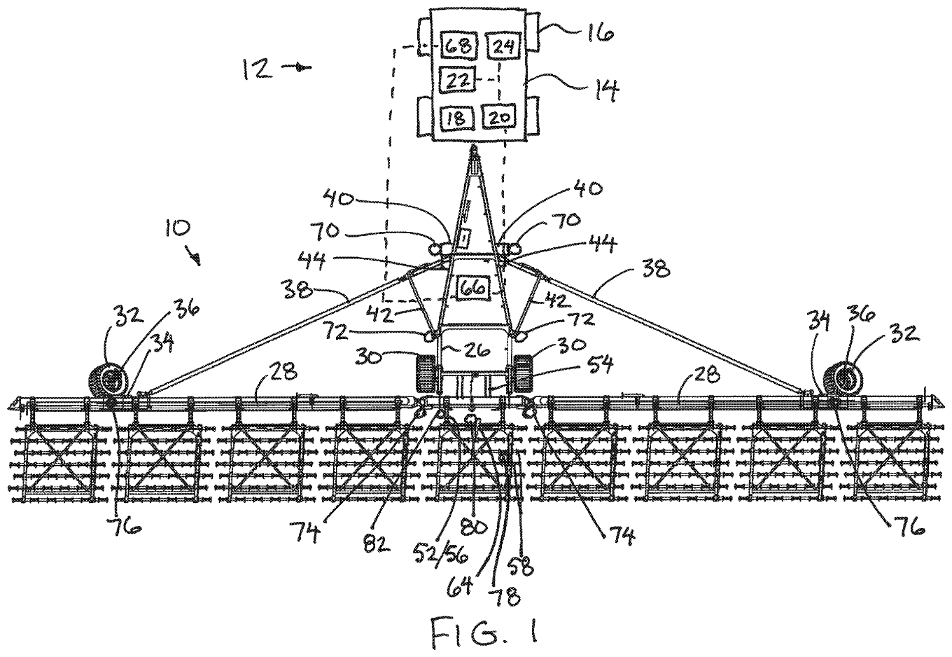

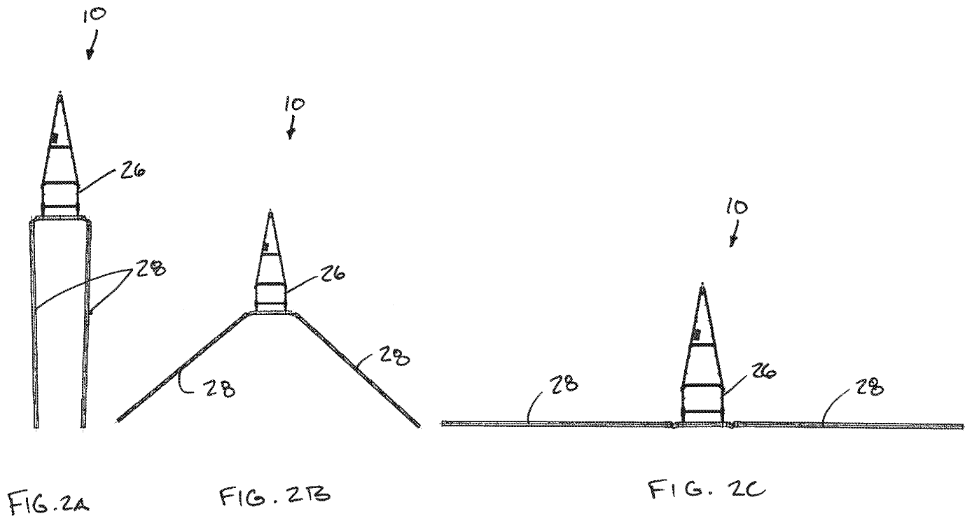

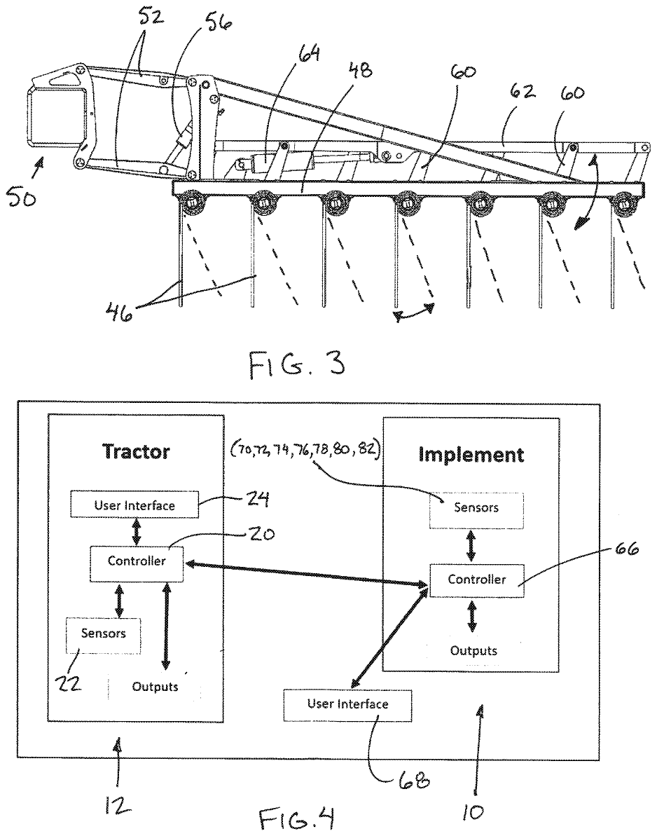

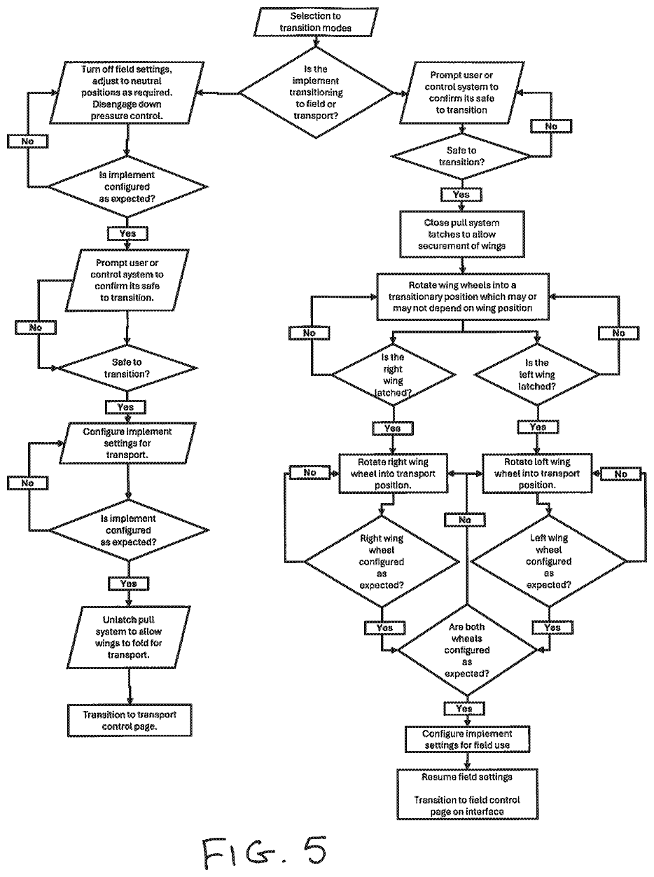

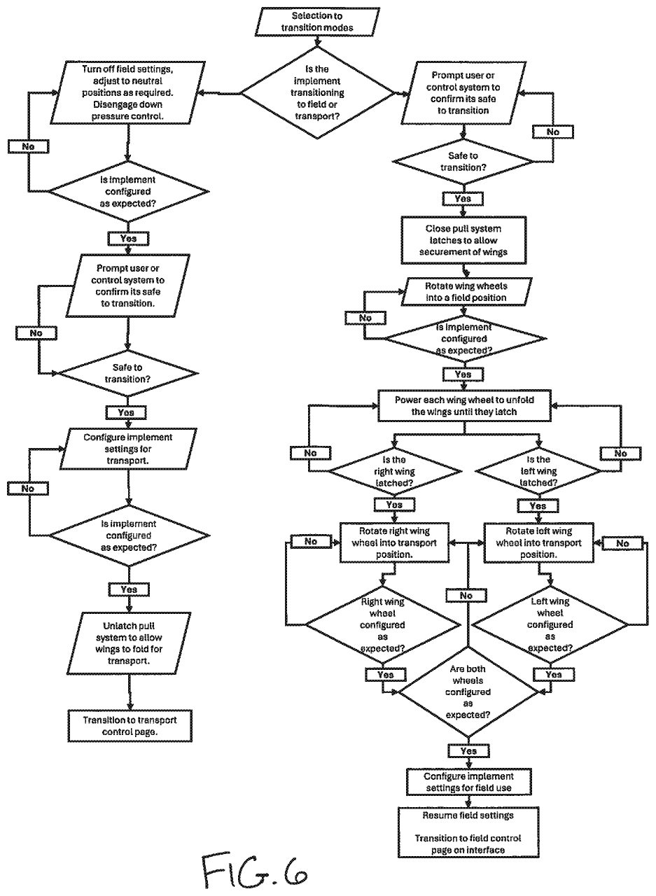

In the drawings like characters of reference indicate corresponding parts in the different figures.

### DETAILED DESCRIPTION

Referring to the accompanying figures there is illustrated a towed agricultural implement generally indicated by reference numeral 10. In the illustrated example, the implement 10 is a harrow arranged for working ground across which the implement is towed by a suitable towing vehicle, for example an agricultural tractor 12.

A typical agricultural tractor 12 with which the implement 10 is used comprises a main frame 14 supported on wheels connected to a motor which drives the wheels in a forward working direction of the tractor. The tractor further includes a hydraulic system including a supply pump driven by the motor to supply pressurized hydraulic fluid and a return reservoir that receives the hydraulic fluid returned from various actuators. A series of control valves of the hydraulic system of the tractor control the flow of hydraulic fluid through a plurality of different hydraulic outputs 18 of the tractor which are arranged to be coupled in communication with various component actuators of the implement for operating the implement.

The tractor further includes a tractor controller 20 in the form of a computer controller having a memory storing programming instructions thereon and a processor for executing the programming instructions to execute the various functions of the tractor as described herein. Furthermore, the tractor controller 20 is arranged to generate various actuation signals for the control valves on the tractor and/or control valves on the implement to operate the various component actuators on the tractor and on the implement for controlling operation of both the tractor and the towed implement. The tractor controller 20 also communicates with a plurality of tractor sensors 22 providing various data inputs into the tractor controller 20 to which the tractor controller is responsive for generating actuation signals and/or displaying data to the operator in the cab of the tractor in the form of output data or prompts requesting input from the operator. A tractor interface 24 of the tractor is provided within the cab of the tractor for interaction with the operator in the form of (i) a display screen for displaying information and (ii) user inputs including touch inputs on the display screen or various buttons, switches and levers and the like for receiving various operator commands from the operator input into the tractor controller 20.

The implement 10 generally comprises a main frame including a centre frame 26 supporting a hitch at the forward end thereof for forming a towed connection to the tractor 12 such that the implement moves together with the tractor in the forward working direction. The main frame further includes a pair of wing frames 28 which are pivoted on the centre frame about respective vertical axes for displacement between a field position and a transport position. In the field position the wing frames extend laterally outward in opposing lateral directions from the central frame. In the transport position, the wing frames are pivoted through approximately 90 degrees from the field position towards one another such that the wing frames extend rearwardly in trailing relation with the central frame.

The main frame is partly supported for movement across the ground by centre wheels 30 carried on the centre frame for rolling movement in the forward working direction. The implement also includes transport wheels 32 supported on the wing frames respectively. Each transport wheel 32 is rotatable on a wheel frame 33 that is pivotal relative to the wing frame about an upright steering axis such that each transport wheel is pivotal relative to the respective wing frame between (i) a transport position in which the wheel is oriented for rolling parallel to the lengthwise direction of the wing frame so as to be oriented for rolling in the forward working direction when the wing frames are in the transport position and (ii) a field position in which the wheel is oriented for rolling perpendicularly to the lengthwise direction of the wing frame so as to be oriented for rolling in the forward working direction when the wing frames are in the field position.

A wheel actuator 34 is operatively connected between each wing frame and the corresponding wheel frame 33 that supports the respective transport wheel 32 thereon in the form of a linear hydraulic actuator. In this manner extending and retracting the wheel actuator 34 acts to pivot and steer the transport wheel 32 between the field and transport positions. Each transport wheel may be further associated with a drive motor 36 in the form of a hydraulic motor operatively connected at a hub of the transport wheel so as to drive rotation of the transport wheel in either forward or rearward directions of rotation when actuated accordingly.

The wing frames are supported in the field position by respective brace arms 38 in which each brace arm is pivotally coupled at a rear end to the wing frame at a location spaced laterally outward from the connection of the wing frame to the centre frame and is pivotally coupled at a forward end to the central frame at a location spaced forwardly from the connection of the wing frame to the centre frame. A releasable latch assembly 40 selectively retains the front ends of the brace arms coupled to the central frame in the field position.

A guide arm 42 is associated with each brace arm 38 in the form of a pivotal link which is pivoted at one end on the brace arm in proximity to the front end of the brace arm and is pivoted at the opposing end at an intermediate location on the centre frame between the latch assembly 40 and the connection of the wing frame to the centre frame. The guide arm 42 serves to support the brace arm relative to the centre frame as it is displaced between the field position and the transport position when the latch assembly is released.

The latch assembly 40 associated with each wing frame comprises a clamp including a fixed jaw and a movable jaw which is displaced towards and away from the fixed jaw to selectively clamp a pivot pin fixed at the forward end of the respective brace arm within the clamp in a latched position of the latch assembly. A latch actuator 44 is operatively connected between the central frame and the movable jaw of each latch assembly to displace the latch assembly between a latched position retaining the pivot pin at the forward end of the brace arm 38 coupled pivotally with the central frame and an unlatched position in which the brace arm is detached from the central frame and is guided by the guide arm 42 to be positioned generally alongside the wing frame in the transport position. The latch actuator 44 of each latch assembly is a hydraulic linear actuator operated by the hydraulic systems of the tractor similarly to the other actuators of the implement.

The implement further includes a plurality of ground engaging tools, in the form of tines 46 according to the illustrated embodiment, which are carried on the main frame for selectively engaging the ground as the implement is displaced across the ground in the forward working direction in the field position.

In other types of implements, when the ground engaging tools include discs or furrow openers, and the like, the tools may be carried on various frame sections to be lowered relative to the main frame into a working position engaged with the ground or raised relative to the main frame into a stored position disengaged from the ground. In this instance, tool deployment actuators are provided in operative connection between the main frame and one or more tools respectively in the form of a hydraulic linear actuator to raise and lower the tools as the actuators are extended and retracted.

In the illustrated embodiment in which the ground engaging tools comprise tines 46 of a harrow, a plurality of section frames 48 are provided at spaced apart positions along a toolbar 50 that extends along the wing frames and the centre frame of the implement. A parallel 4-bar linkage 52 is operatively connected between each frame section 48 and the toolbar 50 to support the section frame 48 such that it extends generally rearward from the toolbar in a working orientation while remaining adjustable in elevation relative to the toolbar for accommodating various ground contours. A pressure actuator 56 is operatively connected to each 4-bar linkage 52 in the form of a hydraulic linear actuator in which varying the hydraulic pressure supplied to the actuator will vary the down pressure applied to the section frame 48 relative to the toolbar which in turn affects the elevation of the section frame relative to the main frame. Varying the pressure within the pressure actuators 56 can also cause the tines 46 to be lifted from the ground into a disengaged position.

The toolbar can also be rotated relative to the main frame using one or more toolbar actuators 54 through a range of approximately 90 degrees which causes the section frames to be displaced from a rearward orientation to an upward orientation extending from the toolbar to position the tines 46 out of use and disengaged from the ground for transport.

Each section frame 48 supports a plurality of tines 46 thereon on respective tine bars 58 which are mounted parallel to the toolbar at varying spacing from the toolbar within a generally common plane of the section frame. Each tine bar 58 is thus oriented generally perpendicular to the forward working direction in the field position. Each tine bar 58 supports a plurality of the tines 46 thereon at spaced apart positions along the length of the bar in which all of the tines on each bar extend radially at a common angular orientation relative to the bar. A crank member 60 extending radially from each tine bar 58 controls the angular rotation of the bars 58 relative to the section frame which in turn varies the angle of the tines relative to the section frame. An actuator bar 62 extends across the tine bars 58 in pivotal connection to each of the cranks 60 such that longitudinal displacement of the actuator bar 62 rotates all of the tines within a common section frame 48 together with one another. A tine actuator 64 is operatively connected between each section frame 48 and the respective actuator bar 62 in the form of a hydraulic linear actuator such that extending and retracting the tine actuator 64 commonly rotates all of the tine bars 58 to vary the tine angle of the tines 46 relative to the respective section frame.

In the arrangement described above, one or more of the toolbar actuators 54, the pressure actuators 56, and the tine actuator 64 can be used cooperatively to engage all of the tines with the ground or disengage the tines from the ground similarly to the tool deployment actuators used on other types of implements.

All of the actuators of the implement described above comprise component actuators for controlling operation of the associated components of the implement in which the component actuators are connected to respective hydraulic outputs of the tractor. Control valves associated with each actuator for operating the actuator are typically provided on the tractor but may also be provided on the implement or as a combination of control valves on the implement and the tractor for controlling the supply and return of hydraulic fluid between the actuators and the hydraulic system of the tractor. The control valves of the actuators may include electronic controllers associated therewith to permit control of the actuators using electronic actuation signals generated by the tractor controller, the implement controller, or a combination of the two controllers.

The tool deployment actuators of the implement, and in particular the pressure actuators 56 described above associated with the section frames 48 of the implement respectively comprise phasing actuators which are interconnected by being hydraulically linked in a phasing relationship. In this manner, one or more of the actuators comprises a master actuator that is initially actuated, for example using an actuation signal, while the other actuators in the series are hydraulically linked such that each subsequent actuator is actuated by a supply of hydraulic fluid that is expelled from a proceeding actuator within the series of actuators. The actuators are hydraulically linked so as to be operable in unison in response to a single actuation of the master actuators. In the instance of hydraulic linear actuators, the actuators are provided with phasing ports that are in open communication with the internal chambers of the actuator when the actuator reaches one or both ends of a range of movement of the actuator corresponding to an end of travel position of the actuator. In this instance, when the actuator reaches an end to travel position, hydraulic fluid can bypass the actuator while the actuator remains fully extended or fully retracted to communicate hydraulic fluid through the actuator to the next actuator in the series.

In this instance, displacing all of the actuators to a prescribed end of travel position synchronizes all of the actuators at a common end of travel position. Further actuation of the actuators to respective intermediate positions continues with the actuators being synchronized with one another. In the event that normal operating forces acting on the actuator during normal usage causes leakage of hydraulic fluid that results in one or more actuators being out of sync with the other actuators in the series, displacing the actuators to the end of travel position allows hydraulic fluid to bypass through the phasing ports to re-synchronize the position of the actuators relative to one another.

In the illustrated embodiment, the tine actuators 64 may be similarly arranged as phasing actuators which are hydraulically linked with one another in a phasing relationship. In each instance of actuators arranged in a phasing relationship, the master actuator of the series can be located on the section frame 48 that is mounted in trailing relationship with the central frame so that all of the section frames on the wing frames locate slave actuators that are hydraulically linked to the master actuators on the central section frame.

The implement includes an implement controller 66 carried on the implement frame in the form of a computer controller having a memory storing programming instructions thereon and a processor for executing the programming instructions to perform the various functions of the controller described herein. The implement controller 66 is arranged for communication with the tractor controller to send and receive data between the tractor controller and the implement controller, as well as being in communication with the various actuators of the implement to control actuation of the actuators by generating suitable control signals for the actuators as outputs of the implement controller.

The implement controller 66 is further arranged to communicate with a separate user computer device 68 such as a computer tablet having a display screen to output data and various inputs including buttons and/or a touchscreen for receiving operator commands. Preferably the implement controller 66 on the implement is arranged for wireless communication with the user computer device 68 which can be operated by the operator within the cab of the tractor. The implement controller 66 communicates with the tractor controller so that data from various sensors on the implement can be communicated to the tractor controller and data relating to various sensors and operating conditions of the tractor can be communicated to the implement controller. In addition, data including prompts and the like can be displayed to the operator by communicating information directly from the implement controller to the user computer device 68 or by communicating data from the implement controller 66 through the tractor controller which then communicates with the operator through the tractor interface 24.

The sensors of the implement include a plurality of condition sensors arranged to detect respective operating characteristics of the implement, for example the operating condition of the wing frames or any other components relating to the wing frames such as the latch assembly condition, the wing orientation, or the transport wheel orientation as examples described in further detail below.

More particularly the implement includes a latch sensor 70 associated with each latch assembly which detects whether the latch assembly is in the latched or unlatched position.

A guide arm angle sensor 72 is associated with each guide arm 42 for measuring an angle of the guide arm relative to the central frame which provides an indication of the position of the brace arm 38, and in turn an orientation of the wing frame relative to the central frame. Alternatively, a wing angle sensor 74 may be operatively connected directly between the wing frame and the central frame for measuring the relative angle of the wing frame relative to the central frame as it is displaced between the field and transport positions.

A wheel angle sensor 76 is associated with each transport wheel to measure the relative angle of the wheel frame that carries the transport wheel thereon as it pivots relative to the wing frame between the field position and transport position of the respective transport wheel.

A tine angle sensor 78 is provided for measuring the tine angle of one set of tines 46 relative to the respective section frame 48. Preferably if only a single tine angle sensor is provided, the tine angle sensor is provided on the central section frame 48 locating the master actuators of any phasing actuators thereon. The tine angle sensor may directly measure the angle of one of the tine bars 58 relative to the section frame, or the tine angle sensor may be operatively connected to measure the linear displacement of the actuation bar 62 or the tine actuator 64 associated therewith from which the tine angle can be calculated.

One or more pressure sensors 80 may be associated with the pressure actuators 56 to determine the operating condition of the down pressure system that controls the down pressure of the tines relative to the ground. In addition to, or in place of the pressure sensor, a pitch sensor 82 may be operatively connected to the 4-bar linkage 52 of one or more section frames to monitor the pitch or elevation of the section frame relative to the toolbar on the main frame.

The implement controller 66 is in communication with all of the sensors to receive the sensed operating conditions of the associated components of the implement communicated to the implement controller. The controller can directly respond to the sensed data to automatically generate suitable instructions used for guiding the wing frames of the implement from the field position to the transport position or from the transport position to the field position in response to the sensed data meeting prescribed criteria stored on the controller.

In some instances, the instruction generated by the implement controller is a prompt communicated to the user through the user computer device 68 or through the tractor interface as described above, to receive a subsequent operator input commands that in turn actuates appropriate actuators to perform the desired function.

In other instances, the instructions generated by the implement controller comprise activation signals for one or more actuators to actuate the appropriate actuators to perform the desired function.

In an assisted mode of operation as shown in FIG. 6, the implement controller functions to assist an operator in transitioning the implement to the field position or the transport position. When transitioning to the transport mode is selected by the operator, the controller will turn off the field settings and adjust the implement to neutral positions as required, including disengaging of the down pressure actuators 64. The implement monitors the sensors to determine if the implement is then configured as expected. Once the expected configuration has been reached, an instruction is generated by the implement in the form of a prompt to the user or to the control system to confirm that it is safe to continue transitioning to the transport mode. The implement controller then further generates suitable actuation signals to configure the implement settings for the transport mode including rotating the toolbars to pivot the frame sections upwardly and actuating rotation of the transport wheels of the wing frames into the transport position. The implement controller monitors the appropriate sensors to determine that the implement is further configured as expected. Once the implement controller determines that the implement is suitably configured as expected, the latch actuators are activated into the unlatched position to allow the wing frames to be folded rearwardly towards the transport position. The interfaces then transition to a transport control page. The operator can then safely advance the tractor in the forward working direction and the wings will safely fold rearwardly from the field position to the transport mode.

When transitioning to the field mode is selected by the operator within the assisted mode of operation of FIG. 6, the implement controller will prompt the user of the control system to confirm that it is safe to transition. Once it is determined that it is safe to transition either by user input or monitored sensor input, the latch actuators are operated into a latched position so as to be ready to receive the pivot pins inserted and retained in the latch assemblies respectively. The implement controller then actuates the wheel actuators to rotate the transport wheels of the wing frames into a transitioning position steered from the transport position, in which the transitioning position may or may not depend upon the angular position of the respective wing frames relative to the central frame. The operator is then permitted to reverse the tractor and the central frame of the implement connected to the tractor in a rearward direction opposite to the forward working direction which will cause the wing frames to be folded forwardly relative to the central frame from the transport position to the field position guided by the steering of the transport wheels. In one instance, the angular position of the transport wheels on the wing frames may be gradually steered from the transport position to the field position dependent upon the sensed angular orientation of the respective wing frame relative to the central frame. The implement controller can independently monitor the angular orientation of each wing frame and independently control the steering angle of the respective transport wheels to attempt to fold the wing frames in unison to the greatest degree possible. Each wing frame is independently monitored such that when the respective wing frame reaches the field position and the pivot pin of the respective brace arm is received and retained within the respective latch assembly as detected by the corresponding latch sensor, the transport wheel of that wing frame can be automatically actuated by the implement controller to pivot fully into the field position. Once both wing frames are pivoted into the respective field positions and the corresponding latch assemblies are confirmed in the latched position, the implement controller can automatically generate suitable actuation signals to configure the implement settings to be ready for field use including pitching the section frames down into the field usable range. Sensors are monitored to confirm the implement is configured as expected so that field settings can resume and the user interface can transition to a field control page.

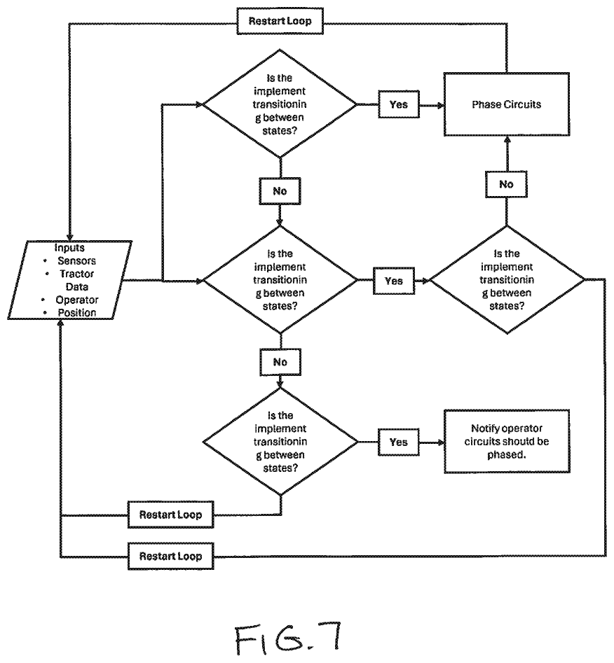

Turning now to FIG. 7, in an automated mode of operation the operator can initially select whether transitioning to transport mode or transitioning to field mode. When transitioning to the transport mode is selected by the operator, the controller generates appropriate actuation signals to turn off the field settings and adjust any component actuators to neutral positions as required including disengaging of the down pressure control. The implement controller then monitors sensors of the implement and tractor to determine if the implement is configured as expected. If configured appropriately, the implement controller generates an instruction signal in the form of a prompt displayed to the user through one of the user interfaces. When the user responds that it is safe by inputting an appropriate response to the interface, the implement controller will generate appropriate activation signals to configure the implement settings for transport including pitching the section frames fully up and rotating of the wing wheels into the transport position. Once the feedback from sensors to the implement controller determines that the implement is configured as expected, the latch assemblies for the brace arms are actuated by the implement controller into the unlatched position to allow the wing frames to fold for transport. Lastly the implement controller transitions the interface to the transport control page.

Alternatively, if transitioning to field mode is selected by the operator, the public controller generates instruction signals to prompt the user or the control system to confirm it is safe to transition. Once sensor data received by the implement controller indicates to the implement controller that it is safe to transition, the latch assemblies are actuated into the latched position to be ready to receive the brace arms latched therein. Furthermore, the implement controller generates control signals to rotate the wing wheels into the field position. If sensor feedback to the implement controller indicates that the implement is configured as expected, actuation signals can be generated for the drive motors on the transport wheels of the wing frames to unfold the wings into the field position under power of the rotating transport wheels while the tractor and the central frame remain stationary. Independent sensors associated with the latch assemblies generate appropriate signals to independently verify that each of the wing frames has reached the field position and is adequately latched in the respective latch assembly. Sensors also determine if the transport wheels on each wing are configured as expected in the field position. Once the implement controller determines by sensor feedback that both wheels are configured as expected, appropriate control signals are generated by the implement controller to configure the implement settings to get ready for field use including pitching down the tools into the field usable range. Once the implement is configured as expected based on sensor data fed back to the implement controller, actuation signals are generated by the implement controller to resume field settings for the implement and to transition the relevant interface to the field control page.

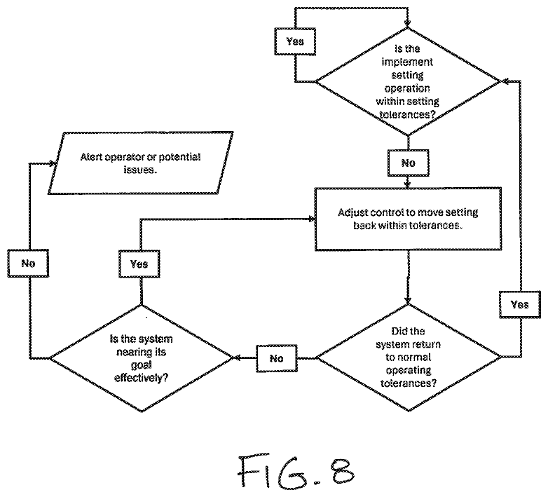

In view of the known problem of multiple tools actuated by hydraulic actuators that are connected in series becoming out of synchronicity with one another due to hydraulic fluid leaking between the actuators, the implement controller 66 described herein is further configured to ensure that any component actuators of the implement which are interconnected in a phasing relationship are routinely displaced into the respective end of travel positions of the actuators to resynchronize the actuators with one another, as best shown in FIG. 8. In this regard, the implement controller 66 of the implement actively monitors one or more operating characteristics relating to an operating condition of the ground engaging tools. In this regard the implement controller communicates with a monitoring device which may comprise one or more of the implement sensors described above that monitors the condition of a component actuator of the implement, or one or more of the tractor sensors that monitors a corresponding operating condition of the tractor relating to the instructed operating condition of the implement according to the tractor controls. Phasing criteria is stored on the controller to determine when it is safe to phase or resynchronize the phasing actuators. In this instance, the one or more operating characteristics of the implement monitored by the monitoring device can be compared to the phasing criteria to determine if the implement is transitioning between states such as transitioning of the ground engaging tools between a position engaged with the ground and a disengaged position for example. If the comparison to the phasing criteria determines that the implement is transitioning between states, suitable actuation signals are generated for the actuators in the phasing relationship to resynchronize the phasing actuators before resuming transitioning of the actuators between states as previously prescribed by the operator. Even when the phasing criteria does not indicate that the implement is transitioning between states, the implement controller 66 also uses data from sensors on the tractor or the implement and the like as inputs for comparison to further phasing criteria to determine if the ground engaging tools of the implement are lifted or otherwise positioned or operating such that phasing of the phasing actuators will not damage the equipment or affect the performance of the implement. In such instances, if the implement controller determines that performance of the implement will not be affected by displacing the phasing actuators into the end of travel positions through comparison to the further phasing criteria, the implement controller conducts a further comparison to compare a measured duration since the previous displacement of the phasing actuators into their end of travel positions to a first duration threshold so that controller generates instruction signals to displace the actuators into the end of travel position for re-synchronizing the phasing actuators with one another if the duration exceeds the duration thresholds.

The implement controller also continues to monitor a measured duration since the previous displacement of the phasing actuators into their end of travel positions and compares that duration to a second duration threshold or alert threshold stored on the implement controller. If the second duration threshold is exceeded by the measured duration, regardless of the operating condition of the implement, the implement controller will generate an instruction signal for the user interface to generate an alert or prompt to notify the operator that the phasing actuators should be displaced into their end of travel positions for re-synchronizing. More particularly, the implement controller is arranged to generate an alert to be communicated to the operator in response to the failure to meet the proceeding phasing criteria for that second duration since the previous displacement of the actuators into their end of travel positions. The sensors for determining the operating condition of the implement may include any combination of sensors supported on the implement to directly sense the operating condition of the ground engaging tools and/or tractor data acquired from the tractor controller that is representative of one or more operating characteristics of the implement.

The implement controller 66 according to the present invention further monitors if any of the component actuators begin to drift from their intended settings, again in view of leakage of hydraulic fluid between components of the hydraulic systems of the implement and the tractor. As best shown in FIG. 9, the implement controller monitors any command signals in the form of actuator activation signals generated by the tractor or the implement controllers to control the operating position or characteristic of the implement that is associated with the actuator. The implement controller includes data stored thereon in the form of an expected threshold range of positions for each actuator in association with the activation signals or command signals actively selected for that actuator. The implement controller continues to monitor operating characteristic data sensed or measured by the sensors operating on the implement to determine the actual operating condition of one or more actuators. The controller compares the actual sensed operating condition or sensed operating characteristic to the expected threshold range of positions for that actuator based on the activation signals or command signals actively selected or generated for that actuator to determine if the sensed operating characteristic falls within the threshold range. If the implement is operating within the prescribed threshold range or setting tolerances, the implement continues to operate normally. Alternatively, if it is determined that the sensed operating characteristic is outside of the threshold range, the implement controller generates appropriate corrective command signals for the hydraulic actuator that is out of range to return the operating characteristic of the implement associated with that actuator back to the threshold range. The implement controller is thus arranged to automatically adjust controls to move the sensed operating characteristics back to within the threshold range responsive to determining the operating characteristic is out of range. If the operating characteristic returns to the normal operating tolerances, that is the prescribed threshold range, in response to the corrective command signals in an expected manner, then the implement again continues to operate normally. If the sensed operating characteristics communicated to the implement controller indicate that the sensed operating characteristic does not return to the threshold range in response to the corrective command signal being communicated to the corresponding actuator of the implement, the implement controller performs a further comparison to determine if the corrective command signals for the actuators at least return the operating characteristic closer to the intended threshold range. In this instance, if the sensed operating characteristic is at least approaching the intended threshold range, additional corrective command signals are generated by the implement controller automatically to communicate the corrective command signals to the appropriate actuators to further attempt to return the operating characteristic to the threshold range. Alternatively, if the corrective command signals do not result in the sensed operating characteristic approaching the threshold range, the controller will generate an alert for communication to the operator through one of the user interface as described above.

As described above, as agricultural implements have gotten larger, procedures for transitioning implements between positions for transport and field have become more challenging to accomplish in a timely manner, for implements such as harrows it has also become more challenging to unfold without damaging the implement. Transitions for harrows involve multi step processes requiring the operator to actuate multiple hydraulic circuits and drive the tractor often in reverse to get the implement unfolded correctly. This procedure completed incorrectly often results in damage to implement, and or, significant amounts of down time.

In this disclosure, a harrow or other implement of the prior art requiring a multi step unfolding procedure is equipped with a controller and sensors such that the operator can be guided through the procedure and functions may be automated, such that less input and experience is required from the operator. Rear folding implements such as harrows in the prior art require the operator to reverse the tractor to accomplish unfolding or the transition to field/transport mode. As these implements have become larger the process of reversing to unfold the implement has become more challenging to complete efficiently. Implements of the prior art combatted this issue incorporating a pivoting wheel, which allows the operator to select a wheel angle which accelerates the rate at which the harrow will unfold. Significant operator skill is still required to ensure that each wing latches at the correct time while avoiding equipment damage.

In this disclosure, a rear folding implement such as a harrow may be further provided with a pivoting transport wheel, in which the rotation of the wheels can be powered automatically by the implement controller such that the operator is no longer required to move the tractor when folding and unfolding the implement. This enables the implement to transition between states more efficiently, reduce operator input, and a reduction more efficiently in the probability of implement damage.

Furthermore, as rearward folding harrows have grown in size and functionality, they have also transitioned from supporting their wings with cables to ridged members or pull bars capable of holding each wing in position in both the forward and rearward directions of travel. Each pull bar is held up by guide arms, allowing the pull bar to swing between a free transport position, and a locked or latched position for field operation. Ensuring the latch is fully engaged and remains fully engaged is critical to the safe and damage free operation of these implements. Traditionally the operator the operator may be required to visually verify the latch is fully engaged from the cab of the tractor and must continue monitoring the system during regular use to reduce the risk of an infield unlatch, and the severity of the damage should an unlatch occur.

In this disclosure, a rear folding harrow implement with solid pull bars, and guide arms, is further provided with sensors such that full engagement of the latch may be detected, and the position of the guide arm may be measured directly or indirectly. The sensors are then monitored to provide the operator and other control system functions with a live reading of the latching system state. This removes the requirement for the operator to visually inspect the system from the cab of the tractor, which can be difficult or unreliable in reduced visibility due to weather and field conditions, or common visual impairments.

Since various modifications can be made in the invention as herein above described, and many apparently widely different embodiments of same made, it is intended that all matter contained in the accompanying specification shall be interpreted as illustrative only and not in a limiting sense.

1. A towed agricultural implement comprising:
a central frame arranged for connection to an agricultural tractor for movement across ground in a forward working direction of the agricultural tractor;
two wing frames pivotally coupled to the central frame so as to be moveable relative to the central frame between a field position in which the wing frames extend laterally outward in opposing lateral directions from the central frame and a transport position in which the wing frames extend rearwardly in trailing relation to the central frame;
at least one implement condition sensor arranged to detect an operating characteristic of the implement relating to an operating condition of the wing frames; and
a controller supported on the implement in communication with said at least one implement condition sensor, the controller comprising a memory storing programming instructions thereon and a processor arranged to execute the programming instruction whereby the controller is arranged to generate an instruction for guiding the wing frames of the implement between the field position and the transport position responsive to the operating characteristic sensed by said at least one implement condition sensor.

2. The implement according to claim 1 said instruction comprises a prompt communicated to the operator through a user interface.

3. The implement according to claim 2 wherein the user interface comprises a tractor interface of the agricultural tractor and wherein the controller is arranged to communicate with the tractor interface to communicate the prompt to the user.

4. The implement according to claim 2 wherein the user interface comprises a portable computer device supported remotely from the controller on the implement and wherein the controller is arranged to communicate with the portable computer device to communicate the prompt to the user.

5. The implement according to claim 1 wherein the implement includes a latch assembly arranged to latch the wing frames in the field position and wherein said at least one implement condition sensor comprises a latch sensor associated with the latch assembly whereby the operating characteristic sensed by the latch sensor comprises a latching condition of the latch assembly.

6. The implement according to claim 1 wherein said at least one implement condition sensor comprises a wing angle sensor associated with the wing frames whereby the operating characteristic sensed by the wing angle sensor includes a relative angle of one or both wing frames relative to the central frame.

7. The implement according to claim 1 wherein the implement includes a transport wheel mounted on each wing frame respectively to support the wing frame for rolling movement along the ground in which the transport wheel is pivotal about a wheel assembly axis between a field orientation and a transport orientation, and wherein said at least one implement condition sensor comprises a wheel angle sensor associated with each transport wheel whereby the operating characteristic sensed by the wheel angle sensor includes a relative angle of the associated transport wheel relative to the respective wing frame.

8. The implement according to claim 1 wherein the implement comprises a plurality of component actuators for operating respective components of the implement between different operating positions, and wherein said instruction comprises an actuation signal associated with one or more component actuators for guiding the wing frames of the implement between the field position and the working position responsive to the operating characteristic sensed by said at least one implement condition sensor.

9. The implement according to claim 8 wherein the components of the implement include a latch assembly arranged to latch the wing frames in the field position, wherein one of the component actuators comprises a latch actuator arranged to operate the latch assembly between a latched position and an unlatched position of the latch assembly, and wherein the actuation signal generated by the controller is arranged to actuate the latch actuator.

10. The implement according to claim 8 wherein the components of the implement include a transport wheel mounted on each wing frame respectively to support the wing frame for rolling movement along the ground in which the transport wheel is pivotal about an upright steering axis between a field orientation and a transport orientation, wherein the component actuators of the implement comprise wheel actuators arranged to operate the transport wheels between the field orientation and the transport orientation, and wherein the actuation signal generated by the controller is arranged to actuate the wheel actuators.

11. The implement according to claim 10 wherein said at least one implement condition sensor comprises a wing angle sensor associated with the wing frames whereby the operating characteristic sensed by the wing angle sensor includes a relative angle of one or both of the wing frames relative to the central frame, and wherein the controller is arranged to generate the actuation signals for the wheel actuators so as to dynamically vary orientation of the transport wheels responsive to said relative angle of one or both of the wing frames relative to the central frame.

12. The implement according to claim 1 wherein the components of the implement include a transport wheel mounted on each wing frame respectively to support the wing frame for rolling movement along the ground, wherein the component actuators of the implement comprise wheel motors arranged to drive rotation of the transport wheels respectively, and wherein the actuation signal generated by the controller is arranged to actuate the wheel motors.

13. The implement according to claim 1 wherein the implement includes a plurality of ground engaging tools supported on the main frame for selectively engaging the ground, wherein one or more of the component actuators comprises a tool deployment actuator arranged to operate the ground engaging tools between an engaged position and a disengaged position of the ground engaging tools relative to the ground, and wherein the actuation signal generated by the controller is arranged to actuate the tool deployment actuator.
